(19) United States
(12) Patent Application Publication
(10) Pub. No.: US 2011/0067018 A1
(43) Pub. Date: Mar. 17, 2011

(54) COMPILER PROGRAM, COMPILATION METHOD, AND COMPUTER SYSTEM

(75) Inventors: Kiyokuni Kawachiya, Kanagawa-ken (JP); Tamiya Onodera, Kanagawa-ken (JP); Michiaki Tatsubori, Kanagawa-ken (JP); Akihiko Tozawa, Kanagawa-ken (JP)

(73) Assignee: INTERNATIONAL BUSINESS MACHINES CORPORATION, Armonk, NY (US)

(21) Appl. No.: 12/881,667

(22) Filed: Sep. 14, 2010

(30) Foreign Application Priority Data
Sep. 15, 2009 (JP) 2009-212881

(51) Int. Cl. G06F 9/45

(52) U.S. Cl. 717/156

(57) ABSTRACT

A method, computer program product and system for improving performance of a program during runtime. The method includes reading source code; generating a dependence graph with a dependency for (1) data or (2) side effects; generating a postdominator tree based on the dependence graph; identifying a portion of the program able to be delayed using the postdominator tree; generating delay closure code; profiling a location where the location is where the delay closure code is forced; inlining the delay closure code into a frequent location in which the delay closure code has been forced with high frequency; partially evaluating the program; and generating fast code which eliminates an intermediate data structure within the program, where at least one of the steps is carried out using a computer device so that performance of the program during runtime is improved.

### CROSS-REFERENCE TO RELATED APPLICATION

This application claims priority under 35 U.S.C. §119 from Japanese Patent Application No. 2009-212881 filed Sep. 15, 2009, the entire contents of which are incorporated herein by reference.

### BACKGROUND OF THE INVENTION

The present invention relates to a compiler technique, and more particularly, to improving a program's performance during runtime.

In recent years, dynamic scripting languages such as Perl, Ruby, and JavaScript® have become mainstream. These languages do not have any static types, but are characterized by a mechanism of dynamically and loosely connecting modules to each other. For example, a PHP application often uses an associative array (hash table) for data exchange between modules, instead of class/object-based data exchange like those found in Java®. This means that an interface between modules is determined not by type, but by name. Determination by type increases the degree of freedom of the application while increasing the cost of data exchange. Therefore, an effective compile-time optimization method is becoming increasingly important. For example, in a benchmark study of PHP SugarCRM, a CRM software provided by SugarCRM Inc., runtime processing of associative arrays accounted for approximately 30% of the total resources consumed. Moreover, almost all of global variables, object fields, and the like are represented by associative arrays in PHP.

### SUMMARY OF THE INVENTION

Accordingly, one aspect of the present invention provides a compilation method for improving performance of a program during runtime, the method includes the steps of: reading source code; generating a dependence graph using the source code where the dependence graph includes a dependency for (1) data or (2) side effects; generating a postdominator tree based on the dependence graph; identifying a portion of the program able to be delayed using the postdominator tree; generating delay closure code where the delay closure code performs a delay; profiling a location where the location is where the delay closure code is forced; inlining the delay closure code into a frequent location in which the delay closure code has been forced with high frequency; partially evaluating, after inlining the delay closure code, the program; and generating, after the partial evaluation, fast code which eliminates an intermediate data structure within the program where the intermediate data structure is a data structure no longer needed after the program has been partially evaluated, where at least one of the steps is carried out using a computer device so that performance of the program during runtime is improved.

Another aspect of the present invention provides a computer program product for improving performance of a program during runtime, the computer program product including: a computer readable storage medium having computer readable program code embodied therewith, the computer readable program code including: computer readable program code configured to read source code; computer readable program code configured to generate a dependence graph using the source code where the dependence graph includes a dependency for (1) data or (2) side effects; computer readable program code configured to generate a postdominator tree based on the dependence graph; computer readable program code configured to identify a portion of the program able to be delayed using the postdominator tree; computer readable program code configured to generate delay closure code where the delay closure code performs a delay; computer readable program code configured to profile a location where the location is where the delay closure code is forced; computer readable program code configured to inline the delay closure code into a frequent location in which the delay closure code has been forced with high frequency; computer readable program code configured to partially evaluate, after inlining the delay closure code, the program; and computer readable program code configured to generate, after the partial evaluation, fast code which eliminates an intermediate data structure within the program where the intermediate data structure is a data structure no longer needed after the program has been partially evaluated.

Another aspect of the present invention provides a computer system for improving performance of a program during runtime, the system including: a storage device which stores source code; a main memory; a reading unit for reading the source code into the main memory; a generating unit for generating a dependence graph using the source code where the dependence graph includes a dependency for (1) data or (2) side effects; a generating unit for generating a postdominator tree based on the dependence graph; an identification unit for identifying a portion of the program able to be delayed using the postdominator tree; a generating unit for generating delay closure code where the delay closure code performs a delay; a profiling unit for profiling a location where the location is where the delay closure code is forced; an inlining unit for inlining the delay closure code into a frequent location in which the delay closure code has been forced with high frequency; an optimization unit for partially evaluating, after inlining the delay closure code, the program; and a generating unit for generating, after the partial evaluation, fast code which eliminates an intermediate data structure within the program where the intermediate data structure is a data structure no longer needed after the program has been partially evaluated.

### BRIEF DESCRIPTION OF THE DRAWINGS

FIG. 1 is a hardware block diagram for performing a preferred embodiment of the present invention.

FIG. 2 is a block diagram of functions used in a preferred embodiment of the present invention.

FIG. 3 is a diagram illustrating a relationship among intermediate languages, the execution system, and the profile information.

FIG. 4 is a diagram illustrating a flowchart of compilation processing according to a preferred embodiment of the present invention.

FIG. 5 is a diagram illustrating a data dependence graph generated by a dependence analysis and an example of a postdominator tree.

FIG. 6 is a diagram illustrating a data dependence graph and an example of a postdominator tree in the case of consideration of side effect types.

### DETAILED DESCRIPTION OF THE PREFERRED EMBODIMENTS

Hereinafter, preferred embodiments of the present invention will be described in detail in accordance with the accompanying drawings. Unless otherwise specified, the same reference numerals denote the same elements throughout the drawings. It should be understood that the following description is merely of one embodiment of the present invention and is not intended to limit the present invention to the contents described in the preferred embodiments.

To reduce the amount of resources used by a program, it is preferable to use partial evaluation or other optimization techniques which eliminate data structures. To that end, it is necessary to achieve a clear data flow between the generation site and the use site of the associative array. However, since the generation site of the associative array is far from the use site in a large application, it is difficult to obtain a global data flow between them by analysis. Moreover, the dynamic module coupling itself makes the data flow hard to understand, which further complicates the problem.

An object-oriented language such as Java® requires a runtime cost, called “class-based abstract cost”, which is higher than in earlier languages. Moreover, functions and characteristics within an object-oriented language such as virtual functions and inheritance statically obscure the data flow of a program. This obscuring makes it difficult to remove class-based abstract costs using static optimization methods. Accordingly, in the object-oriented language world, dynamic feedback-driven optimization techniques such as polymorphic inline caching and object profiling have been developed in order to deal with this issue. These techniques enable optimization by estimating the global data flow of the program on the basis of the runtime feedback.

For example, if the global data flow of an object's class information is estimated, optimization has been enabled by inline-expansion of a virtual method for the estimated class and combining it with a subsequent code. However, it is not obvious to apply the feedback-driven optimization technique to associative arrays because even if the global data flow can be estimated, it is not clear how to carry out the optimization with the combination of the generation site code and the use site code of the associative array.

Lazy evaluation is effective in large applications such as Java® WebSphere® Application Server or PHP SugarCRM. Particularly, in a stateless execution model like PHP in which a program runs once for each request, an application's initialization logic runs for each request. However, only a small portion of the data generated by the initialization is likely to be used. Therefore, a lazy evaluation effect is expected. A practical use has not been attained with respect to the technique of systematically performing the lazy evaluation at the compiler level for an imperative language with side effects such as Java® or PHP. This is partly because the cost is reduced if the delayed evaluation is not forced until needed, while the cost is higher if the evaluation is performed without delay.

To enable a source program to be efficiently compiled by syntax-analysis, the source program contains a statement specifying a forward reference. Japanese Unexamined Patent Publication (Kokai) No. Hei 10-11299 discloses a compiler apparatus which includes a token selecting and reading unit which sequentially reads tokens from a token sequence contained in a source program; a lazy evaluation portion storage unit which stores the tokens into a lazy evaluation token storage table if the tokens read by the token selecting and reading unit are those within a lazy evaluation section preset to an arbitrary section of the token sequence; and an evaluation processing unit which sequentially reads the tokens stored in the lazy evaluation tone storage table by the lazy evaluation portion storage unit and then objectifies and outputs the tokens to an object file.

The lazy evaluation technique in a compiler, however, does not provide an effective solution to the problem of higher cost in the case where the evaluation is forced than in the case where the evaluation is not delayed.

It is an object of the present invention to provide a compiler technique capable of improving the performance of an executable code by applying a lazy evaluation to an imperative language with side effects such as Java® or PHP.

The present invention has been provided to achieve the above object, and therefore the present invention solves a problem of a large runtime cost by using a global (inter-procedural) code motion technique based on a feedback for an application having a language with relatively-high data operation runtime cost such as PHP and a loose connection between modules with an associative array or the like.

This technique is achieved by the two compilation steps of:

(1) determining a code fragment of the generation site of data having a high runtime cost and capable of being moved safely by analysis and generating a code for delaying an evaluation for this portion (Level-1 compilation); and
(2) estimating a location where the delay generated in step 1 is forced with high frequency (the use site of the data) on the basis of runtime feedback and achieving code motion by inline-expanding the delay into the use site code to enable powerful optimization such as a partial evaluation (Level 2-compilation).

The delay generation in step 1 temporarily increases the runtime cost for closure creation. If, however, a value produced by the delayed code is not required at all after that, the evaluation cost of the code is removed, similar to a normal lazy evaluation technique, thereby resulting in a gain. In other words, a gain can be achieved by selectively delaying code with a high processing cost, and making sure that the cost of the delay generation itself is lower than the cost of the evaluation without delay.

A characteristic effect according to an embodiment of the present invention is achieved in a situation where the delay generated in step 1 is forced. In this case, optimization is performed by a global code motion to attempt a new type of cost reduction in step 2. Note that the term “code motion” generally means only a local motion within a compilation unit and that the inline expansion has only been used for preexisting functions and methods in a conventional compiler technique. In step 1 of a preferred embodiment of the present invention, the delay is generated aggressively by finding a movable high-cost code. The delay generated here is treated in the same manner as a function closure (object). Therefore, it is possible to use profiling to determine a use site likely to require the delay and to inline-expand the delay into the code with a guard. This enables a global code motion beyond the compilation unit.

If the global code motion (the inline expansion of the delay code) is performed in this manner, an opportunity for more powerful optimization is achieved. For example, if the code of the generation site of the associative array is moved, it is possible to remove the generation and store/load operations of the associative array by using partial evaluation. In PHP, associative array processing costs are extremely high. Therefore a gain through the use of partial evaluation exceeds the cost of delay generation and closure operation in many cases. Moreover, this preferred embodiment of the present invention is also applicable to other high-cost processing such as the generation of a very long character string from a file, as described subsequently in the paragraph of “Mode for Carrying out the Invention”. By way of example, if the code of the use site of the character string is an I/O output of the character string, it is possible to remove the cost of generating the character string by optimizing the rewriting of this processing to DMA processing (zero-copy data transfer) with sendfile.

For example, the PHP code below is taken for instance. Note that a variable defined at top level is treated as a global variable in PHP.

<?php
$user = “akihiko”; $date = date(DATE_RFC822);
start( );
?>

It is assumed that login( ) is called in somewhere in the application from start( ) in the above.

```
function login( ) {
    global $user, $date;
    echo “user $user logined at $date”;
}
```

First, the level-1 compiler finds out a portion of the code which is able to be delayed and delays that portion. Although the compiler generates the following functional intermediate language (A-normal form) in this specification, any other intermediate language such as SSA can be used as long as the intermediate language is able to represent the delayed code. For information about the A-normal form, refer to C. Flanagan et al., “The essence of compiling with continuations”, Proceedings of the ACM SIGPLAN '93 Conference on Programming Language Design and Implementation, pages 237-247, June 1993. In addition, the term SSA means a static simple assignment, which is an intermediate representation where a suffix is appended so that the definition of each variable is textually unique and which is suited for visibly performing dataflow analysis and optimization in compilers.

```
let _0 = date(DATE_RFC822) in
let _{—} = delay_global(fun _{—} ->
    let _{—} = upd_global “user” “akihiko” in
        upd_global “date” _0)
in
start( )
```

In the above, delay_global operation is intended to delay update operation on a global variable. Therefore, the delayed operation represented by (fun_-> - - - ) is not executed, but registered in an execution system. This delay is represented by a closure c=(fn, record) where “fn” represents the entity of a function, and a value unable to be delayed such as _{—}0 is captured in a closure record “record”. Note that “fn” is a compile-time constant while “record” is a variable that holds runtime values. At runtime, each closure can be represented either in a form processed by an interpreter or in a compiled form. This preferred embodiment of the present invention only assumes that a code fragment “(fun_-> - - - )” in an intermediate language is associated with the representation of the closure for subsequent partial evaluation.

During runtime, the global variable is read in the login( ) location.

```
let login _{—} =
    let _0 = load_global “user” in
      let _1 = load_global “date” in
    echo (“user ”. _0.“logined at”._1)
```

If there is no definition of the global variable between start( ) and login( ) the previously-delayed closure c=(fn, record) is fetched from the execution system and processed during load_global execution. A runtime profiler profiles that the closure c is forced during execution of login( )

The level-2 compiler inlines the code fn in the closure delayed based on the profile information into the login( ) function, first. In this regard, a guard is generated at the same time, for determining whether the actually executed code fn′ is equal to the code fn, so that the inlined code corresponding to fn is executed if the guard is hit.

```
let login_fast _{—} =
    let (fn′, record) = delayed_global( ) in
    if (fn′ == fn) then
        let _{—} = upd_global “user” “akihiko” in
        let _{—} = upd_global “date” record#_0 in
        let _0 = load_global “user” in
        let _1 = load_global “date” in
    echo(“user” . _0 . “logined at” ._1)
else login( )
```

It is, however, assumed that record#_{—}0 means readout from the _{—}0 field in the record. Finally, a partial evaluator simplifies the code as follows:

```
let login_fast _{—} =
    let (fn′, record) = delayed_global ( ) in
    if (fn′ == fn) then
      echo(“user akihiko logined at” . record#_0)
    else login( )
```

In other words, this enables the effects of constant folding and intermediate data structure elimination to be obtained without global data flow analysis. In addition, the delayed update operation of a global variable table has been successfully omitted in this location. If there is no update of a global variable after the above login( ), the global variable table generation cost has been completely removed.

An embodiment of the present invention provides an advantageous effect of enabling powerful optimization such as partial evaluation also in an imperative language with side effects such as Java or PHP by performing the steps of: determining a code fragment of a generation site of data which has a high runtime cost and is safely movable; generating code for delaying the evaluation of the portion; estimating a location (the use site of the data), in which the delay generated in the step is forced with high frequency, based on runtime feedback; and inline-expanding the delay into the code of the use site to achieve code motion.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

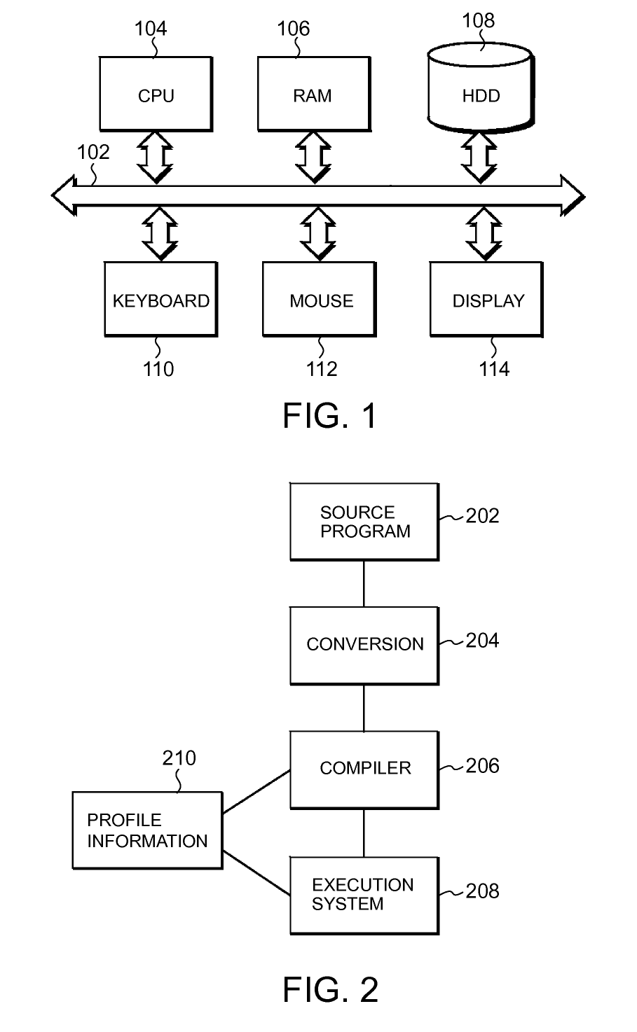

Referring to FIG. 1, a block diagram is shown of computer hardware for achieving a system configuration and processing according to an embodiment of the present invention. In FIG. 1, a system bus 102 is connected to a CPU 104, a main memory (RAM) 106, a hard disk drive (HDD) 108, a keyboard 110, a mouse 112, and a display 114. The CPU 104 can be based on a 32-bit or 64-bit architecture. For example, it is possible to use Pentium™ 4, Core™ 2 Duo, Core™ 2 Quad, or Xeon™ of Intel Corporation, Athlon™ or Turion™ of Advanced Micro Devices, Inc., or the like. The main memory 106 preferably has a capacity of 2 GB or more. The hard disk drive 108 has a capacity of 320 GB or more.

Although not individually shown, the hard disk drive 108 previously stores an operating system. The operating system can be an arbitrary one compatible with the CPU 104, such as Linux™, Windows Vista™, Windows XP™, or Windows™ 2000 of Microsoft Corporation, or Mac OS™ of Apple Computer.

Moreover, the hard disk drive 108 can also store a programming language processor and other programs according to the present invention. In a preferred embodiment of the present invention, PHP can be the programming language.

The hard disk drive 108 can further include a development environment such as a text editor for writing source code for compilation with the program language processor or Eclipse™.

The keyboard 110 and the mouse 112 are used to launch a program (not shown), which is loaded into the main memory 106 from the operating system or the hard disk drive 108 and then displayed on the display 114, and is also used to type characters.

The display 114 is preferably a liquid crystal display, having an arbitrary resolution such as, for example, XGA (1024×768 resolution) or UXGA (1600×1200 resolution). The display 114 is used to display a processing result or an error of a compiler according to the present invention.

Referring to FIG. 2, an outline block diagram of functions is shown according to an embodiment of the present invention. In FIG. 2, a source program 202 is, for example, a source program written in PHP and is stored in the hard disk drive 108.

A conversion module 204 is stored in the hard disk drive 108 and loaded into the main memory 106 by a function of the operating system, and the conversion module 204 has a function of parsing the source program 202 and performing the A-normal form conversion or SSA conversion to generate an intermediate language. The generated intermediate language is located in the main memory 106 or stored in the hard disk drive 108.

A compiler 206, which performs compilation processing according to the present invention, is stored in the hard disk drive 108 and loaded into the main memory 106 by a function of the operating system to convert the intermediate language generated by the conversion module 204 to executable code. Particularly, the compiler 206 is composed of a level-1 compiler and a level-2 compiler as subsequently described.

The executable code generated by the compiler 206 is preferably stored in the hard disk drive 108 and executed by an execution system 208 prepared by the operating system.

When the executable code generated by the compiler 206 is executed in the execution system 208, a runtime profiler (not shown) generates profile information 210. The runtime profiler (“profiler”) can be considered part of the function of the code generated by the compiler 206. Although preferably written to the hard disk drive 108, the profile information 210 can be located in the main memory 106. According to a preferred embodiment of the present invention, the profile information 210 generated in this manner is used by the compiler 206.

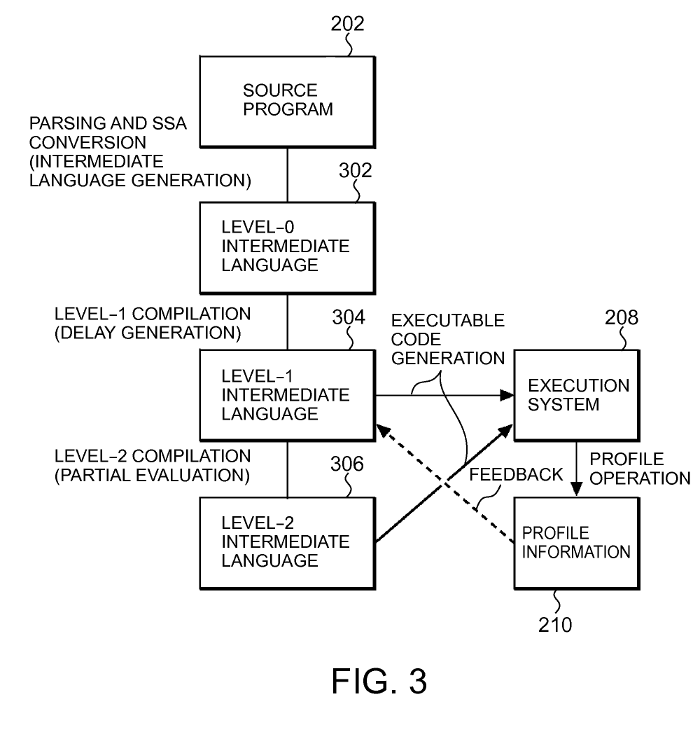

Referring to FIG. 3, a block diagram of generated intermediate language levels is shown. In FIG. 3, the source program 202 is parsed and converted to a level-0 intermediate language 302 like SSA or A-normal form.

A level-1 compiler of the compiler 206 then generates level-1 intermediate language 304 with a processing delay and a profile operation based on the level-0 intermediate language 302 generated.

Upon converting the level-1 intermediate language 304 to an executable code and causing it to run in the execution system 208, the profile information 210 on delay forcing is collected.

If a location is found where a specific delay code is recognized to be forced with high frequency after a certain number of code executions, a level-2 compiler is actuated and optimizes the code replacing the level-1 intermediate language 304 with a faster level-2 intermediate language 306 after partial evaluation of the code.

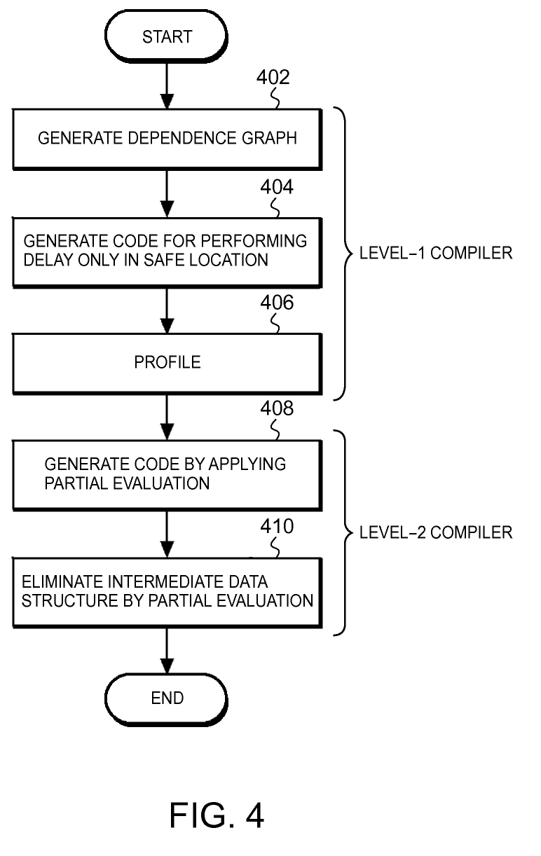

Referring to FIG. 4, there is shown a flowchart for describing the processing steps of the compiler 206 in more detail. As described above, the compiler 206 has two optimization levels, level 1 and level 2, and cooperates with the execution system 208 having a runtime profiler. The level-1 compiler performs code analysis of a procedural language, identifies a code fragment whose evaluation is able to be delayed in the code analysis, and generates a delay closure for this portion.

In FIG. 4, in step 402, the level-1 compiler generates a dependence graph of data and side effects in the code analysis and identifies the portion of the program able to be delayed on the basis of a postdominator tree of the dependence graph.

In step 404, the level-1 compiler examines the possibility of an alias in the data structure and generates a code for performing a delay only in the safe case if it is difficult to determine whether the update of the data structure should be delayed due to the possibility of an alias.

In step 406, the delay closure generated by the code generated by the level-1 compiler is forced in a required location during runtime. The runtime profiler profiles where the delay is forced.

In step 408, the level-2 compiler moves the code of the delay closure which was determined to be forced with high frequency by profiling, by inlining the code of the delay closure into the forced location. In addition, the level-2 compiler generates a fast code by applying partial evaluation.

In step 410, after the code has been partially evaluated, the level-2 compiler replaces the intermediate data structures which are no longer needed after the code has been partially evaluated with an intermediate language capable of explicitly representing the inside of the data structure such as an array. The form of the compile-time data structure does not need to be the same as the form of the runtime data structure in the heap and only the meaning of the operation on the data structure is stored. Subsequently, concrete processing of the individual steps will be described.

Level-1 Compiler

In this specification, a method for identifying a location where the evaluation can be delayed is described. The identification is done by performing a data dependence analysis with respect to the entities of function definitions such as the A-normal form and CPS (corresponding to the basic blocks in the control graph). For example, $x, $y and $z are local variables and an I/O delay is not considered initially in the following:

0: let $x = 1 in
1: let $y = 2 in
2: let $z = $x + $y in
3: let _{—} = echo $x in (* side effect *)
4: let _{—} = callfunc “foo” $z in (* side effect *)
5: ( ) (* side effect = because the side effect is caused by continuation
of this function *)

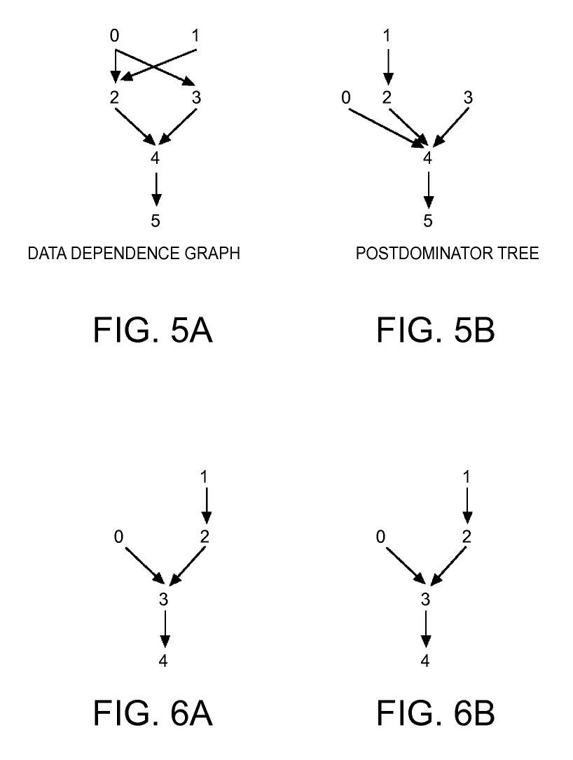

The dependence analysis generates a data dependence graph in FIG. 5A and a postdominator tree of the data dependence graph as shown in FIG. 5B. This processing corresponds to step 402 of FIG. 4.

In the left graph, an edge indicates data dependence. For example, the edge 2→4 represents the fact that callfunc (PHP function call) depends on the argument $z. Moreover, the edge 3→4 is generated as dependence between global side effects of the function call. The generation of the delay code is realized by recursively viewing the postdominator tree in this graph from the bottom. At this point, echo and callfunc are not delayed, but other portions are delayed as far as possible. For example, when “4:let_=callfunc “foo” $z in[ ]” is processed, codes are generated with respect to its parents 0, 2, 3 in the postdominator tree from the top in this order so as to maintain the data dependence between 0, 2, and 3. Moreover, for example, when the node 2 is processed, first, a code “let $y=2 in [ ]” is generated with respect to its parent 1, first, and then “let $y=2 in let $z=$x+$y in [ ]” is generated. Finally, a code 2′ in which the node 2 is delayed is generated since the node 2 has no side effects. The node 3 is not delayed since it has side effects. This processing relates to step 404 in FIG. 4. The resultant code is as follows:

0′: let $x = delay (fun _{—} ->
0: 1) in
2′: let $z = delay ( fun _{—} ->
1: let $y = 2 in
2: $x + $y)
3: let _{—} = echo $x in
4: let _{—} = callfunc “foo” $z in
5: ( )

It should be noted that there is no need to delay everything that can be delayed. What is delayed is determined by cost. For example, with respect to values which need to be used immediately such as the value of an echo function, delaying the value is worthless. The question of whether to delay a constant such as 0′ in the case of no echo is divisive. If the constant is an associative array or a data structure, the constant can be delayed, because it is very likely that the cost of access to constant data can be removed by using the optimization technique of subsequent partial evaluation. Alternatively, assuming that this kind of constant is not delayed, the readout from the constant data structure and closure forcing can be profiled separately from each other and then fed back to the level-2 compiler. The computation of $z=$x+$y can be delayed since its cost is high to a certain degree in PHP. In the case of an associative array operation, the cost of the operation is further increased and therefore the operation is delayed.

Notes on the case of delaying the update of a data structure

In the case of PHP, an associative array data structure, by default, does not include an alias. Specifically, the data structure is as follows:

$x = null;
$x[“key”] = “hello”;
$y = $x;
$y[“key”] = “world”;
echo $x[“key”]; // hello

The assignment on the second line does not represent an alias creation like in a Java object, but a value copy. The compiler of the present invention assumes that an associative array is treated as an immutable value in PHP. The above program is converted to a program which does not consider side effects on the heap as follows:

let $x = null in .
let $x = update “key” “hello” $x in
let $y = $x in
let $y = update “key” “world” $y in
echo (load “key” $x)

At runtime, the update operation can be turned back to an efficient destructive operation on the heap on the basis of a reference count or analysis. For example, if the reference count is used, a runtime reference count addition which is meaningless at compile time is entered as $y=$x.

A problematic case occurs when a variable or a data structure contains a reference assignment (=&) operation which creates an alias. For example, $y=& $x[“abc”] creates such an alias. This breaks down the foregoing assumption that the array is an immutable value. This alias is problematic when considering that the update operation is delayed by the method described in the aforementioned section “Level-1 compiler”. For example:

```
let foo $x $y =
    let $x = update “abc” “def” $x in
    let _{—} = echo $y in
    bar $x
```

First, if the PHP function is defined as function “foo($x, $y) { - - - }” in the source program and a deep value copy of PHP semantics is used, an alias cannot exist between $x and $y and therefore the following delay is allowed anytime (For information about the deep value copy, refer to PHP(d) or PHP(g) in A. Tozawa, et al., “Copy-on-Write in the PHP Language”, Proceedings of the 36th Annual ACM SIGPLAN—SIGACT Symposium on Principles of Programming Languages (POPL 2009), Savannah, Ga., USA, Jan. 21-23, 2009, pp. 200-212, January, 2009.

```
let foo $x $y =
    let $x = delay (fun _{—} -> update “abc” “def” $x)
    let _{—} = echo $y in
    bar $x
```

If a shallow copy of PHP semantics is used or the PHP function is defined as “function foo(&$x, &$y) { - - - }” using pass-by-reference, this delay is likely to be risky.

It is because the update of the array can actually affect $y.

In this embodiment, the execution system level solution described below is used for this problem. Specifically, a flag “$x#contains_alias” is set to determine whether an alias exists in the array $x and this flag is checked at runtime to determine whether the delay is allowed. If the check is unsuccessful, a path for actually performing the update operation is created. Alternatively, it is also possible to add processing of forcing the delay just created, with the number of paths kept to be one. This enables the condition to be equivalent to one where no delay has occurred. Therefore, the code is as follows:

```
let foo $x $y =
    let delay_ok = not $x#contains_alias in
    let $x = delay (fun _{—} -> update “abc” “def” $x)
    let $x = if delay_ok then $x else force $x in
    let _{—} = echo $y in
    bar $x
```

The flag $x#contains_alias is able to be set at the time of reference assignment such as $y=& $x[“abc”].

For a PHP object, a delay is able to be performed by the same check. It should be noted that, when the level-1 compiler algorithm is applied to the program shown below, there is likely to be dependence between the operations of $o1 and $o2 and therefore the dependence needs to be added as a branch of the graph. This branch, however, does not mean that the dependence always exists. Therefore there is no need to abandon the delay of $o1 due to the presence of dependence of $o1 to the echo statement.

```
function foo($o1, $o2) {
    $o1->name = “akihiko”;
    $o1->address = “yamato”;
    echo $o2->name;
    bar($o1);
}
```

The above program is delayed as shown below. The compiler according to this embodiment treats the PHP object $o1 as a value with a pointer reference to an associative array $o1#fileds which represents a field. The operation <- represents an update of a writable record.

```
let foo $o1 $o2 =
    let fields = $o1#fields in
    let delay_ok = not fields#contains_alias in
    let fields = delay (fun _{—} ->
        let fields = update “name” “akihiko” fields in
        update “address” “yamato” fields)
    in
    let _= $o1#fields <- (if delay_ok then fields else force fields) in
    let _{—} = echo (load $o2#fields “name”) in
    bar $o1
```

If aliases are created for the roots of $o1 and $o2, an update of the $o2#fileds array is forced in the load operation safely. The delay in the update of an object reduces the cost equivalent to one in the case of an array, first. It is because PHP is an un-typed language; therefore a field operation is represented by an associative array operation (hash table operation) during runtime. Moreover, in PHP, a default value of a field can be written into a class declaration. Some runtimes record these values as a compile-time constant array. The constant array is used as it is when the field is read. A copy for each object of this array is first created when the object is written to. However, the cost of the copy is significantly high. If the writing into the object can be delayed to the end of the program via partial evaluation, this cost can be removed.

More precise delay generation with consideration given to the side effect type

When the data dependence graph is generated by the technique described in aforementioned “Level-1 compiler” section, a more precise delay is enabled by clarifying detailed data dependence between side effects. This enables the global table operation to be delayed even if the global table operation is represented by side effects as described above.

The side effect types are considered as follows:

GW: Writing to global variable

GR: Reading global variable

IO: IO processing

T: Maximum side effect

For example, a side effect can be specified for the above example code by labeling each “let” statement as follows:

0: let_{IO} _{_{—}}0 = date(DATE_RFC822) in
1: let_{GW} _{_{—}} = upd_global “user” “akihiko” in
2: let_{GW} _{_{—}} =upd_global “date” _0 in
3: let_{T} _{_{—}} = start ( ) in
4: ( )

Since there is no interference between 10 and GW at present, no edge is created. Dependence between GW and GW and dependence from T to an arbitrary most recent side effect are added, thereby obtaining a graph shown in FIG. 6A and a postdominator tree shown in FIG. 6B. The program is viewed from the top (1) to determine a depending node based on the history of the side effects observed until then and (2) to add the dependence.

GR, GW: A branch to more recent one of the most recent T and GW is added.

IO: A branch to more recent one of the most recent T and 10 is added.

T: If T is most recent, a branch is added. If GW and IO are more recent than T, dependences on both are added.

Thereafter, delay generation is able to be added in the same manner as shown in the aforementioned “Level-1 compiler” section:

let _0 = date(DATE_RFC822) in
let _{—} = delay_global (fun _{—} ->
let _{—} = upd_global “user” “akihiko” in
upd_global “date”_0)
in
start ( )

It should be noted, however, that it is necessary to use a special operation, delay_global, in order to register the delay closure of the global variable table. As for the delay closure containing the side effect, the execution system always needs to store a last registered closure with respect to each side effect. Further, when a new closure is registered in delay_global, the runtime needs to store the link from the new closure to the last registered closure. In closure forcing, all closures on the link are forced while tracing the link back to the past.

Regarding global variables, it is also possible to consider delay for update of the variables individually. In this case, the GW/GR annotations need to be more detailed on the respective variables.

### Profiler

The profiler profiles where the delay is forced. The processing described below corresponds to step 406 in FIG. 4. Although the data delay forcing normally occurs within a library due to a process which is reading data (for example, echo statement) or writing data (update operation of an associative array), it is desirable to perform actual profile at a user-level code point outside the library because:

(1) In PHP, the operation of data structures like associative arrays occur within a native library written in C which makes it difficult to perform profile at a level within the library; and
(2) Since the library is called from many locations, it is likely that a frequently-hit guard is not able to be generated if delay forcing is profiled within the library (for example, within the echo implementation).

To solve this problem, the profiler performs profiling of a value at an earlier time than the actual data delay forcing at the user-level code point. Specifically, there is a method in which the level-1 compiler inserts an appropriate profile code into a generated code. At present, it is possible to list a library operation whose argument value is obviously used immediately with respect to PHP and the argument, for example, as follows:

argument x of echo x

key k and array x of update k v x (note that the value v to be inserted into the array is not used immediately)

For this operation and argument, the level-1 compiler inserts the profile operation into the user-level code in the following form:

let x=profile x 0 in echo x
let k=profile k 1 in let x=profile x 2 in update k v x

The first argument of the profile operation is a value which can indicate a delay and the second argument is a call site identifier which is unique across all profile operations. At runtime, the profile x id operation takes in (1) value x for profile and (2) the identifier id of the call site as arguments: if x is a delay closure (fn, record), the pair of fn and the call site identifier id is stored in a global location.

### Level-2 Compiler

A level-2 compiler performs the following two processes:

(1) If it is determined that there is a code fn of a closure forced with high frequency in the corresponding profile operation with respect to each call site identifier id, the code is inlined with a guard at the call site. This process corresponds to step 408 in FIG. 4. (2) A resulting code is optimized by partial evaluation.

More specifically, in (1), the profile operation output by the level-1 compiler is replaced with an fn intermediate code with a guard. In this case, it is unlikely to be able to obtain an efficient code in the subsequent partial evaluation unless versioning of the subsequent code is performed. However, this method is not described in detail here.

As to (2), an example of a technique of achieving a partial evaluation is described below.

Let_{GW} _{_{—}} = upd_global “user” “akihiko” in
Let_{GW} _{_{—}} = upd_global “date” record#_0 in
Let_{GR} _{_{—}}0 = load_global “user” in
let_{GR} _{_{—}}1 = load_global “date” in
echo (“user ” . _0 . “logined at ” . _1)

A code fragment after the above closure inline is discussed below. Since it is generally more convenient to make parameters of side effects such as environment explicit for the partial evaluator, the parameters are made explicit.

```
fun global->
    let global = upd_global “user” “akihiko” global in
    let global = upd_global “date” record#_0 global in
    let _0 = load_global “user” global in
    let _1 = load_global “date” global in
    echo (“user ” . _0 . “logined at ” . _1)
```

This conversion is achieved by rewriting the code based on side effect annotations and then simplifying the code with beta-reduction, as follows:

let_{GW}_{_{—}}=e1 in e2->fun global->let global=e1 global in e2 global
let_{GR} x=e1 in e2->fun global->let x=e1 global in e2 global

Another problem is that a runtime value such as record#_{—}0 cannot be calculated on the associative array in the normal constant folding. Therefore, upd_global and load_global are defined, not at runtime, but at compile time:

upd_global key val arry=fun cons nil->cons key val (arry cons nil)
load_global key arry=arry (fun key′ val a->if key=key′ then val else a) error

This technique converts a Church-encoded “key val” list to a representation of the compile-time array, instead of a runtime array. The above definition is a function for processing this array. The same applies to the case of generating code using a normal list instead of the Church-encoded list. The point is that a data structure containing a runtime value is able to be represented by using an intermediate language in which the content of the data structure is explicitly shown in the intermediate code (in short, of a functional language).

Upon (1) performing exhaustive beta-reduction and constant folding of the program and (2) after inlining the above definition into the program, the following code can be obtained:

fun global->echo (“user akihiko logined at”. record#_{—}0)

Thereafter, the side effect parameter, which was once made explicit, is made implicit again, by which a code in a desired form can be obtained.

echo (“user akihiko logined at”. record#_{—}0)

However, if the partial evaluation is unsuccessful, efficiency decreases unless the runtime array operation (a call of the hash table operation) is left in the remainder code, instead of the compile-time array operation, which is slow because of the list operation. The device can be achieved by modifying the partial evaluator with Sumii, a program evaluator for returning a pair including a compile-time value and a remainder code so that the compile-time array operation is present only as a compile-time value and not present in the result code. Refer to E. Sumii et al., “A Hybrid Approach to Online and Offline Partial Evaluation, Higher-Order and Symbolic Computation”, v.14 n. 2-3, p. 101-142, September 2001.

### Eliminating Delay

The following processing corresponds to step 410 in FIG. 4. Delay processing is costly. Therefore, if a gain higher than the delay cost is not obtained by the level-2 compilation, it is possible to perform recompilation to cancel the delay processing. This case can be divided into the two cases described below.

(1) Although the delay (a) is generated and (b) is forced with high frequency, the delay is in a location which can not be captured by a profile, such as within an extension library. Otherwise, although the delay is used within the user code, it is not used frequently. Therefore the use site is not determined to be optimized for the delay code in the level-2 compilation.
(2) Although a delay is generated and is forced with high frequency within the user level code, it is not expected to increase the performance by cost reduction as a result of trying the level-2 compilation.

In case 1, the profiler is able to make the determination. In case 2, the determination can be only based on heuristics. There is, for example, heuristics for estimating how much the cost is reduced by the code after the partial evaluation in comparison with before the partial evaluation. If an associative array is handled here, some estimation can be made by simply comparing the amount of reduction in the number of load/update operations which appear in the result code with before the partial evaluation. If the number of processes reduced per inline in one lazy evaluation is smaller than a preset threshold, the generated delay is determined to be canceled.

If the delay is determined to be canceled, the level-1 compilation is rerun with respect to the code including the corresponding delay generation in order to generate a code which does not delay the corresponding portion, and the original code is replaced with the new code.

Although the above embodiment has been described by giving an example of PHP as a programming language, the present invention is not limited thereto, but is applicable to any arbitrary language, in which a lazy evaluation is used, such as Java®.

Moreover, although a standalone environment is assumed in the shown example, it is also possible to assume a compilation environment on the server in which generally PHP is used.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

### DESCRIPTION OF REFERENCE NUMERALS

102 System bus
104 CPU
110 Keyboard
112 Mouse
114 Display
106 Main memory
108 Hard disk drive
202 Source program
204 Conversion module
206 Compiler
208 Execution system
210 Profile information

1. A compilation method for improving performance of a program during runtime, the method comprising the steps of:
reading source code;
generating a dependence graph using said source code wherein said dependence graph includes a dependency for (1) data or (2) side effects;
generating a postdominator tree based on said dependence graph;
identifying a portion of said program able to be delayed using said postdominator tree;
generating delay closure code wherein said delay closure code performs a delay;
profiling a location wherein said location is where said delay closure code is forced;
inlining said delay closure code into a frequent location in which said delay closure code has been forced with high frequency;
partially evaluating, after inlining said delay closure code, said program; and
generating, after said partial evaluation, fast code which eliminates an intermediate data structure within said program wherein said intermediate data structure is a data structure no longer needed after said program has been partially evaluated,
wherein at least one of the steps is carried out using a computer device so that performance of said program during runtime is improved.

2. The compilation method according to claim 1, wherein the step of generating delay closure code further comprises the steps of:
determining whether a data structure possibly has an alias; and
generating, in a safe case, said delay closure code if it is difficult to determine whether an update to said data structure should be delayed due to said data structure possibly having said alias.

3. The compilation method according to claim 1, further comprising the step of converting, before generating said delay closure code, said source code into SSA.

4. The compilation method according to claim 1, wherein said program's source code is written in PHP.

5. A computer program product for improving performance of a program during runtime, the computer program product comprising:
a computer readable storage medium having computer readable program code embodied therewith, the computer readable program code comprising:
computer readable program code configured to read source code;
computer readable program code configured to generate a dependence graph using said source code wherein said dependence graph includes a dependency for (1) data or (2) side effects;
computer readable program code configured to generate a postdominator tree based on said dependence graph;
computer readable program code configured to identify a portion of said program able to be delayed using said postdominator tree;
computer readable program code configured to generate delay closure code wherein said delay closure code performs a delay;
computer readable program code configured to profile a location wherein said location is where said delay closure code is forced;
computer readable program code configured to inline said delay closure code into a frequent location in which said delay closure code has been forced with high frequency;
computer readable program code configured to partially evaluate, after inlining said delay closure code, said program; and
computer readable program code configured to generate, after said partial evaluation, fast code which eliminates an intermediate data structure within said program wherein said intermediate data structure is a data structure no longer needed after said program has been partially evaluated.

6. The computer program product according to claim 5, wherein the computer readable program code configured to generate delay closure code is further configured to:
determine whether a data structure possibly has an alias; and
generate, in a safe case, said delay closure code if it is difficult to determine whether an update to said data structure should be delayed due to said data structure possibly having said alias.

7. The computer program product according to claim 5, further comprising computer readable program code configured to convert, before generating said delay closure code, said source code into SSA.

8. The computer program product according to claim 5, wherein said source code is written in PHP.

9. A computer system for improving performance of a program during runtime, the system comprising:
a storage device which stores source code;
a main memory;
a reading unit for reading said source code into said main memory;
a generating unit for generating a dependence graph using said source code wherein said dependence graph includes a dependency for (1) data or (2) side effects;
a generating unit for generating a postdominator tree based on said dependence graph;
an identification unit for identifying a portion of said program able to be delayed using said postdominator tree;
a generating unit for generating delay closure code wherein said delay closure code performs a delay;
a profiling unit for profiling a location wherein said location is where said delay closure code is forced;
an inlining unit for inlining said delay closure code into a frequent location in which said delay closure code has been forced with high frequency;
an optimization unit for partially evaluating, after inlining said delay closure code, said program; and
a generating unit for generating, after said partial evaluation, fast code which eliminates an intermediate data structure within said program wherein said intermediate data structure is a data structure no longer needed after said program has been partially evaluated.

10. The computer system according to claim 9, wherein said generating unit for generating delay closure code comprises:
a determining unit for determining whether a data structure possibly has an alias; and
a generating unit for generating, in a safe case, said delay closure code if it is difficult to determine whether an update to said data structure should be delayed due to said data structure possibly having said alias.

11. The computer system according to claim 9, further comprising a converting unit for converting, before generating said delay closure code, said source code into SSA.

12. The computer system according to claim 9, wherein said source code is written in PHP.
